(19) United States
(12) Patent Application Publication
(10) Pub. No.: US 2006/0071571 A1
(43) Pub. Date: Apr. 6, 2006

(54) Device and method for manufacturing a stator of an electrical machine

(76) Inventors: Ingolf Groening, Lohr (DE); Ingo Hahn, Lohr (DE); Helmut Kunkel, Wiesthal (DE); Joachim Bach, Karlstadt (DE)

Correspondence Address: MICHAEL J. STRIKER, 103 EAST NECK ROAD, HUNTINGTON, NY, 11743, US

(21) Appl. No.: 11/231,191

(22) Filed: Sep. 20, 2005

(30) Foreign Application Priority Data
Sep. 21, 2004 (DE) 10 2004 045 659.3

(51) Int. Cl. H02K 3/48; H02K 15/14

(52) U.S. Cl. 310/214; 29/596

(57) ABSTRACT

A component for an electrical machine has a body having a T-shaped cross section including rib and a head, and a front side located diametrically opposite to the head and oriented parallel to the latter, and also provided with a front recess which is substantially symmetrical around an axis of symmetry and extends longitudinally.

### BACKGROUND OF THE INVENTION

The present invention is based on the general class of dynamoelectrical machines and describes various embodiments of machine components and a method for manufacturing machines of this type according to the definitions of the species in the independent claims.

Numerous devices and methods are known from the related art that make it possible to manufacture an electrical machine using individual components. Typically, the stator ring of an inner or outer rotor is first assembled out of individual components and then secured using an outer guide, e.g., a support tube.

Unexamined patent application DE 101 19 642 A1 discloses a stator ring with a yoke having an external hexagon shape and an annular inner shape, the stator ring being composed of a core with longitudinal recesses and windings located thereon on the inside, the windings being placed on separate, removable winding carriers. The configuration includes wound poles and non-wound intermediate poles, the non-wound poles being connected as a single component by the stator ring.

Unexamined patent application GB 2 224 399 A discloses a stator composed of a large number of individual segments, to simplify the manufacturing and winding processes. After the windings are installed, the individual segments are assembled, resulting in the stator with winding.

Patent document DE 196 43 561 C1 discloses the possible design of a stator ring in FIGS. 1 through 8 using identical, T-shaped or X-shaped individual segments, which can be first wound separately and then assembled to form the stator ring. Once the segments were assembled, they also served as the outer shell of the stator. This document includes all technical features of the definition of the species of the present invention and is the most obvious related art. The individual segments—which are the poles—described here are realized in such a manner, however, that they must supplement each other, as shown in FIGS. 7 and 8, to form a winding chamber with groove slots.

The object shown as an alternative in FIGS. 5 and 6 shows that the winding space is not completely closed and, with this embodiment, it is also necessary to wind the windings directly on the thread-like ridges in the T-segment with application of mechanical tension. When the winding space is not closed, e.g., the formation of magnetic flux is negatively affected, and the rotor-side protection of the windings toward the outside and against adjacent windings is reduced.

### SUMMARY OF THE INVENTION

The object of the present invention, therefore, is to design a machine and a method for its manufacture such that prefabricated windings can be used in particular, with the winding space being closed as completely as possible and the highest possible copper factor being produced. In addition, cost-effectiveness of the realization is increased.

The present invention provides new, previously unknown ways for realizing the multiple-component primary part of an electrical machine. This is accomplished according to the present invention by the fact that a pole of a primary part has a T-shaped cross section and is composed of a rib and a head, the rib having a front recess on its front side diametrically opposed to the head and oriented parallel thereto, the front recess being symmetrical around the axis of symmetry and extending along the entire length.

The primary part is the stationary component of the electrical machine. With a rotationally symmetrical motor, this would be the stator, for example. In principle, however, this could also be the primary part of a linear motor. The primary part is typically designed as a core composed of laminated sheet-metal disks, the sheet-metal disks being joined with each other using stamping, pressing, adhesive bonding or welding methods. One skilled in the art understands that other suitable materials can be selected as necessary.

The T-shape of the pole according to the present invention, which is formed using a rib and a head, makes it possible to quickly and easily install the winding on the pole, e.g., by simply sliding on windings that were preferably manufactured externally, or by using windings installed directly. Due to its symmetry, the front recess extending along the entire length in the front side of the rib diametrically opposed to the head forms two identical legs on the front side that can be oriented, via simple reshaping, substantially perpendicular to the rib and, therefore, practically parallel to the head. The winding is therefore securely fastened to the rib via the head and a base capable of being produced subsequently.

The reshaped base legs extend past the winding space, closing it off in a protective manner. The fact that the winding spaces are partially enclosed by the head and base enables the winding spaces to accept additional copper; this increases the copper factor and improves the power density of the machine. The fact that the poles are symmetrical enables them to be manufactured easily and economically, in large quantities, using few manufacturing steps. The characterizing features therefore completely fulfill the requirements set forth in the object of the invention.

The rib preferably includes, on each of its lateral faces, a lateral recess that extends along the entire length, is located at the level of the base of the front recess and extends parallel thereto. This simplifies the reshaping of the legs, because the material on the side to be compressed was reduced, and a bending edge is simultaneously produced, thereby enabling precise shaping.

In addition, instead of being designed integral with the rib, the head could be mounted on the rib using a form-fit connection. This results in greater flexibility in terms of installing the windings, e.g., head could be installed only after the winding process is completed. A mechanical connection would be recommended in this case; it would be realized using matching recesses and projections. This ensures simple assembly and more secure retention.

As an alternative, the object is achieved by the present invention in that a pole has an axis of symmetry and a T-shaped cross section, and is composed of a rib and a head, a base part being installed—using a form-fit connection—on the front side of the rib diametrically opposed to the head, the base part being symmetrical around the axis of symmetry and extending along the entire length.

The same advantages exist here as those described above with reference to the first object. Manufacture of the pole is simplified, however, since shaping is not carried out, and the base is mounted on the rib as a separate part.

The form-fit connection also serves as a guide. In this case as well, the winding is securely fastened to the rib via the base, the base legs extending past the winding space and delineating/closing it off from the secondary part. The fact that the winding spaces are formed by the head and base enables them to accept additional copper; this increases the copper factor and improves the power density of the machine. The fact that the poles are symmetrical enables them to be manufactured easily and economically, in large quantities, using few manufacturing steps. The head is preferably mounted on the rib using a form-fit connection in this case as well, to obtain the same advantages that exist with the first object.

It is recommended, in particular, that the form-fit connection be realized using matching recesses and projections (e.g., dovetailed), thereby resulting in secure retention and optimal guidance during assembly.

The present invention enables the realization of an electrical motor with a multiple-component primary part with poles, according to one of the embodiments described above in particular, and best utilizes the advantages according to the present invention in particular when the primary part is composed of individual segments that, when assembled, form said primary part. This concept results in an electric motor that is economical to manufacture, has a high copper factor and closed grooves. Additional advantages include a high power density, high torque and reduced torque ripple due to reduced detent torque, and a simplified production technique.

Comparable results are obtained when the primary part includes pole inserts distributed around the circumference, and the corresponding poles are realized in a manner according to the present invention. Reference is made here to publication DE 101 19 642 A1, FIGS. 1 and 3, with the corresponding description of the figures. The basic concept of pole inserts of this type is described here. One skilled in the art is prompted to refer to the cited publication when realizing embodiments of primary parts of this type according to the present invention.

The present invention enables realization of a simplified method for manufacturing an electrical machine with identically-configured poles, in terms of installing the windings, in particular, in that the pole winding is placed on the rib or a winding core before the winding space is closed. The winding need not be guided, in a complicated manner, around the laterally projecting head and base leg. Instead, it can be easily placed on the rib or winding core using the head and/or base.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1a shows various embodiments of a crude, single-component pole, in accordance with the present invention.

FIG. 1b shows a winding installed on the crude pole, in accordance with the present invention.

FIG. 1c shows the finished, wound pole, in accordance with the present invention.

FIG. 2a shows a crude, dual-component pole configured in an alternative manner compared to FIG. 1a, in accordance with the present invention.

FIG. 2b shows a winding installed on the crude pole.

FIG. 2c shows the finished, wound pole, in accordance with the present invention.

### DESCRIPTION OF THE PREFERRED EMBODIMENTS

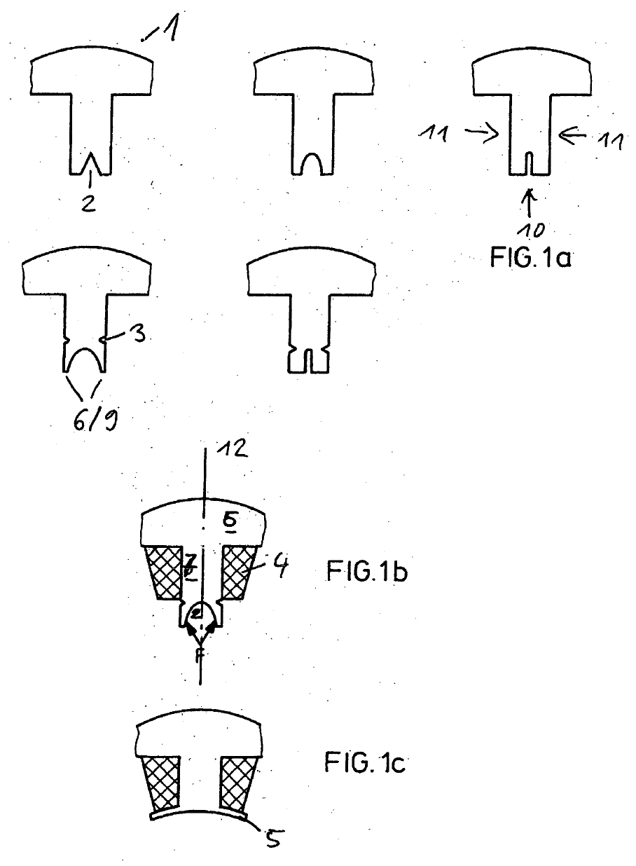

Single-component crude part 1 in FIG. 1a includes a head part 6, a rib 7 and a groove 2 formed along the longitudinal axis of rib 7. Groove 2 is located on front side 10 of rib 7 diametrically opposed to head part 6, as mirror images relative to the axis of symmetry. This groove can be configured in the shape of a V or U, and be more or less wide. Other advantageous groove profiles are also feasible and are within the ability of one skilled in the art. As an option, a further groove 3 is shown on lateral surface 11 of rib 7, which can also be configured in the shape of a V or a U. Groove 3 is equidistant from head 6 on both sides, and is located at the level of the base of front-side groove 2, extending parallel thereto. Groove 3 extends along the entire length of the crude part and serves to simplify the bending of leg 9, since the material that would have to be compressed during bending is not even there.

A crude part 1 with a winding 4 installed on rib 7 is shown in FIG. 1b. Winding 4 was either wound directly on the rib, or it was manufactured separately and then slid into place from rib side 10. Typically, the winding packet is also pressed to form the outer edges of the winding and optimize the copper factor. Together with core 6, 7 and 5, after winding, a trapezoidal cross section of the entire assembly results. A force F is also indicated in FIG. 1b. This force F must be applied to bring the legs into the shape shown in FIG. 1c using a suitable tool.

FIG. 1c shows the finished pole, which has a nearly H-shaped cross section with curved upper and lower delineation and encloses the winding between rib 7, head 6 and base 5 such that it extends past the dimensions of core 1 as little as possible, if at all. Due to the curved configuration of head 6 and base 5, pole 1 is a segment of a ring. If a plurality of identical segments of this type is combined, a cylindrical body composed of individual segments is obtained, the wall thickness of which is determined by the dimensions of the head and base width, and the rib height. The arc radius determines the diameter of the cylinder. A cylinder of this type can serve as a stator of a motor that includes poles distributed evenly around the circumference.

It should also be noted here that it is not necessary to wind every pole. According to other concepts, wound and non-wound poles or groups of poles are distributed around the circumference in an alternating manner. The application of the principle according to the present invention is recommended to realize wound and non-wound poles.

It would also be feasible to insert the poles subsequently into a cylindrical stator with corresponding recesses in its cylinder wall, thereby also resulting in a stator with poles distributed evenly around the circumference.

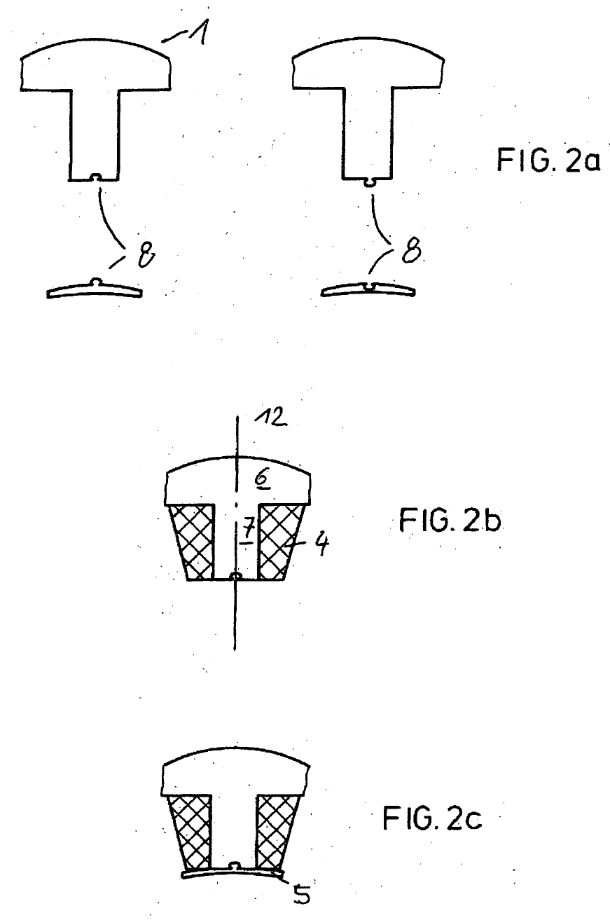

An alternative embodiment of a crude pole 1 is also shown in FIGS. 2a through 2c. The statements made above with regard for FIGS. 1a through 1c apply in this case. In this case, however, crude pole 1 is designed as a multiple-component part from the beginning, and base 5 is not realized by shaping rib 7, but by using a separate component 5 that is connected with rib 7 in a form-fit manner using a suitable joining method 8.

In every case described above, it would be feasible to also realize head 6 using a form-fit connection 8 with a head part that is also separate, or by shaping the side of the rib diametrically opposed to the base. The use of the object shown in FIGS. 2a through 2c to realize a multiple-component and segment-based stator is therefore rendered obvious and is recommended.

It will be understood that each of the elements described above, or two or more together, may also find a useful application in other types of methods and constructions differing from the types described above.

While the invention has been illustrated and described as embodied in a device and method for manufacturing a stator of an electrical machine, it is not intended to be limited to the details shown, since various modifications and structural changes may be made without departing in any way from the spirit of the present invention.

Without further analysis, reveal foregoing will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A component for an electrical machine, comprising a body having a T-shaped cross section including rib and a head, said body having a front side located diametrically opposite to said head and oriented parallel to the latter, said front side being provided with a front recess which is substantially symmetrical around an axis of symmetry and extends longitudinally.

2. A component as defined in claim 1, wherein said rib has two lateral faces and is provided on each of said lateral faces with a lateral recess that extends along an entire length, is located at a level of a base of said front recess and extends parallel to the latter.

3. A component as defined in claim 1; and further comprising means for form-fit connection of said head and said rib with one another.

4. A component as defined in claim 3, wherein said means for form-fit connection of said head and said rib with one another include corresponding interacting recesses and projections.

5. A component as defined in claim 1, wherein said rib has lateral surfaces and is provided with projections that extend in a plane of said lateral surfaces and limit said front recess, so that said projections form a base which, when viewed together with said rib and said head, result in an H-shaped cross-section.

6. A component as defined in claim 1; and further comprising a pole selected from the group consisting of a wound pole and non-wound pole.

7. A component for an electrical machine, comprising a base having a T-shaped cross-section with an axis of symmetry, the body including a web, a head, and a base part installed via a form-fit connection on a front side of said rib which is diametrically opposite to said head, said base part being substantially symmetrical around said axis of symmetry and extending longitudinally.

8. A component as defined in claim 7, wherein said head and said rib are formed as parts which are form-fit with one another; and further comprising means for form-fit connection of said head and said rib with one another.

9. A component as defined in claim 8, wherein said means for form-fit connection of said head and said rib with one another include corresponding recesses and projections.

10. An electrical machine, comprising a primary part having a plurality of components wherein at least one of said components is configured as defined in claim 1.

11. An electrical machine with a primary part having a plurality of components, wherein at least one of said components is configured as defined in claim 7.

12. An electrical machine, comprising a single-component primary part provided with poles, each of said poles being configured as a component defined in claim 1.

13. An electrical machine, comprising a single component primary part with poles, each of said poles being configured as a component defined in claim 7.

14. A method of manufacturing an electrical machine with a component configured as defined in claim 1, the method comprising the steps of placing a pole winding on said rib; delineating a winding space using a part selected from the group consisting of said base part, said head part and both connected to said rib.

15. A method of manufacturing an electrical machine with a component configured as defined in claim 7, the method comprising the steps of placing a pole winding on the rib; and then delineating a winding space using a part selected from the group consisting of a base part, a head part, and both connected to said rib.
